(19) United States
(12) Patent Application Publication
(10) Pub. No.: US 2010/0017236 A1
(43) Pub. Date: Jan. 21, 2010

(54) Method and System for Configuring a Vehicle

(75) Inventors: Ashley Robert Duddle, Fareham (GB); Steven Henry Perham, Walton-On Thames (GB)

Correspondence Address: GOODWIN PROCTER LLP;PATENT ADMINISTRATOR, 53 STATE STREET, EXCHANGE PLACE, BOSTON, MA, 02109-2881, US

(73) Assignee: Airmax Group PLC, Verwood (GB)

(21) Appl. No.: 12/487,268

(22) Filed: Jun. 18, 2009

(30) Foreign Application Priority Data
Jul. 18, 2008 (GB) 0811097.5

(51) Int. Cl. G06Q 40/00; G06Q 90/00; G06F 7/00

(52) U.S. Cl. 705/4; 705/500; 701/1; 701/2

(57) ABSTRACT

A method and system for providing insurance, the method including making an agreement to provide insurance for a vehicle and reconfiguring the vehicle to alter the driving performance of the vehicle based on the agreement. The system includes a server arranged to provide a user interface through which a user can make an agreement for the provision of insurance and to generate instructions for reconfiguring a vehicle to alter the driving performance of the vehicle based on the agreement.

### CROSS-REFERENCE TO RELATED APPLICATIONS

This application claims priority to British Patent Application No. GB 0811097.5, filed on Jun. 18, 2008, the disclosure of which is hereby incorporated herein by reference in its entirety.

### FIELD OF THE INVENTION

This invention concerns a method, system and data carrier for providing insurance and for configuring a vehicle.

### BACKGROUND OF THE INVENTION

It is a typical requirement that to drive a vehicle on a public highway, the driver of the vehicle has to be insured against damage that could be caused if the driver was to have an accident in the vehicle and the like and insurance premiums are typically based on, amongst other things, the driver's age, driving history, type of vehicle, and a location where the vehicle is typically parked. However, it may be desirable for a vehicle owner to be able to purchase insurance with a lower premium without having to change the vehicle or the location where the vehicle is parked.

### SUMMARY OF THE INVENTION

In one aspect, the invention relates to a method of providing insurance including making an agreement to provide insurance for a vehicle and reconfiguring the vehicle to alter the driving performance of the vehicle based on the agreement.

In another aspect, the invention relates to a system for providing insurance including a server arranged to provide a user interface through which a user can make an agreement for the provision of insurance and to generate instructions for reconfiguring the vehicle to alter the driving performance of the vehicle based on the agreement.

The invention also relates to a computer program.

By reconfiguring the vehicle to alter the driving performance of the vehicle, in response to making an agreement for the provision of insurance, an insurance provider can provide the option of cheaper insurance premiums in return for drivers restricting the performance of their vehicles. For example, drivers who accelerate less quickly and/or drive at a slower speed may be less likely to be involved in an accident and therefore, have a lower risk of claiming on their insurance. Accordingly, altering the performance of a vehicle may reduce the likelihood of an insurance provider having to make a payout, allowing the insurance provider to reduce the costs of insurance for those vehicles. It will be understood that the invention is not limited to the provision of cheaper vehicle insurance but the invention may allow an insurance provider to change the conditions of the agreement, for example, reduce excess payable on the insurance or the amount of insurance cover.

It will be understood that a “tracker” device on a vehicle that allows one to track the location of a vehicle does not alter the driving performance of a vehicle as it does not affect how the vehicle moves. The term “driving performance” as used herein means a characteristic of the movement of the vehicle, such as acceleration, top speed, deceleration (braking performance), and the like. The term “insurance” as used herein means a promise of reimbursement in the case of loss, financial or otherwise.

The driving performance of the vehicle may be altered by altering the acceleration, maximum speed, characteristics of the vehicle that affect emissions from the vehicle or other characteristic of the vehicle. For example, the characteristics of the vehicle that may be altered are the amount of fuel injected into the engine (adjustments in the “richness” of the burn and/or the maximum amount of fuel that can be injected), injection timing, variable valve timing, (for a turbocharged engine) the amount of boost maintained by a turbocharger, the rev limiter, manifold air pressure and/or adjusting the ride condition (for example, through lowering or increasing the height of the suspension, increasing the stiffness of the suspension, increasing or decreasing the air pressure in the tires). The types of emissions that may be affected are hydrocarbon, nitrogen oxide, carbon oxide, carbon monoxide and/or carbon dioxide emissions. The characteristics of the car may be altered to allow for/facilitate the combustion of other fuel types. In one embodiment, the performance of the vehicle is altered by limiting the maximum acceleration, revolutions and/or speed of the vehicle.

Furthermore, the vehicle may be reconfigured such that changes to the driving performance occur at a specified time, for example, periodically, such as at midnight or during rush hours, e.g., between 7 am and 10 am and 4 pm and 6 pm. This may be desirable, as it may be more likely that an accident will happen at certain times in the day and, by reducing the driving performance at those times, the likelihood of the vehicle being involved in an accident may be reduced. It will be understood however that the specified time may not be regular times daily but could be specified weeks, months or years. For example, the vehicle may be reconfigured such that changes to the driving performance occur every December when there is an increased likelihood of drunk driving.

The vehicle may be reconfigured such that the driving performance is altered for a specified driver/operator. For example, the insurance agreement may cover the driving of the vehicle by a specified driver and the vehicle may be configured to alter the driving performance when that driver uses the vehicle. For example, the vehicle may be arranged to identify the driver from a sensor, such as a unique code associated with the driver communicated by an ignition key or a switch operated by the driver to indicate the driver operating the vehicle, and select an operator driving performance (profile) for the vehicle. The driving performance may be selected from one of a plurality of driver profiles associated with the vehicle. This may be desirable wherein the insurance for the vehicle covers the vehicle for more than one driver and the agreement requires that the driving performance for the vehicle is altered dependent on the driver. For example, the drivers may be of different ages, experience or genders and, in order to mitigate the increased risk associated with drivers of different ages, experience or gender, the vehicle may be reconfigured to alter the driving performance for those drivers.

The vehicle may be reconfigured to alter the driving performance under specified ambient conditions, such as specified weather conditions, for example in ambient conditions when snow, ice or standing water is deemed likely. For example, the vehicle may include one or more sensors, such as a temperature sensor, for monitoring the ambient conditions and the vehicle may be reconfigured to alter the performance of the vehicle in response to a specified ambient condition being measured, for example a temperature below 0° C.

The method may include the owner and/or driver of the vehicle reconfiguring the vehicle in response to a request from an insurance provider. Alternatively, the insurance provider or contractor may reconfigure the vehicle, preferably, remotely.

In another aspect, the invention relates to a method including receiving a request for emission characteristics for a vehicle and, in response to receiving the request, reconfiguring the performance characteristics of the vehicle to alter the emission characteristics of the vehicle.

The vehicle may include an electronic control system for controlling the operation of at least one component of a vehicle, the electronic control system including a microcontroller, and programmable non-volatile memory. The microcontroller is configured to process input signals from at least one vehicle sensor to provide output signals for controlling the at least one vehicle component in accordance with program data read at least partly from the programmable non-volatile memory. The step of reconfiguring the vehicle may include reprogramming the memory with program data that alters the performance of the vehicle as desired.

However, other methods of reconfiguring are envisaged, such as altering the maximum possible displacement of a throttle pedal. In this way, in response to a driver purchasing a type of insurance, the performance of the driver's vehicle may be altered in response to the purchase of that type of insurance. For example, the driver may be allowed to purchase insurance with a lower premium by having his vehicle altered to limit the performance of the vehicle, such as maximum speed or acceleration, of the vehicle.

The microcontroller may be configured to process input signals from at least one vehicle sensor to provide output signals for controlling the at least one vehicle component in accordance with program data read at least partly from the programmable non-volatile memory. The method may include obtaining data based on sensor signals and pertaining to the vehicle during its operation, analysing the data based on sensor signals, and determining an appropriate set of program data based on the analysis. The method can further include causing a programming unit on board the vehicle to program the appropriate set into the programmable non-volatile memory.

By obtaining sensor data pertaining to the vehicle during its operation, characteristics of the actual usage and operation of the vehicle can be deduced by analysing the sensor data. By determining an appropriate set of program data based on the analysis, the performance of the vehicle component or components can be adapted to suit the determined characteristics. By causing a programming unit to program the appropriate set into the programmable non-volatile memory, it is possible to use a bespoke set of data, allowing for better optimisation of the performance characteristics of the vehicle component to suit the actual conditions and/or control of the vehicle's performance as required by the conditions of the insurance purchased by the driver. Because it is the program data read by the microcontroller from the programmable non-volatile memory (“Keep-Alive Memory”) that is adapted, a more radical adaptation can be effected than would be possible by modifying a limited set of variables that the microcontroller may maintain in registers (“scratch pad memory”) when controlling the at least one vehicle component. In effect, the control strategy can be modified. By causing a programming unit on board the vehicle to carry out the programming, adaptation to actual usage and operation of the vehicle are achievable. A further advantage is that such adaptation can be achieved without reducing the length of the service intervals of the vehicle.

In an embodiment, the data based on sensor signals and pertaining to the vehicle during its operation includes data indicative of a position of the vehicle, at least implicitly associated with timing information. The implicit association may be through the point in time at which the data indicative of a position of the vehicle is requested or received. An effect is to obtain data that is relevant to the adaptation of an electronic control system for controlling the operation of at least one component of a vehicle. The location of the vehicle determines the environment which it is in and the demands placed on it. Environmental conditions, such as temperature, humidity, visibility, etc., have a relatively large effect on the operation of vehicle components. The demands placed on the vehicle are quite closely related to its location, for example where legal requirements, road surface conditions and typical gradients are concerned.

In an embodiment of the method, the data based on sensor signals and pertaining to the vehicle during its operation include data based on signals from at least one vehicle sensor. An effect is to adapt control of the vehicle component(s) to relevant parameters indicative of how the vehicle is being used and of how well vehicle sub-systems are performing.

An embodiment of the method includes obtaining at least one operator profile that indicates the operating style of at least one operator. An effect is to provide a control strategy that is appropriate to medium and/or short-term future operation of the vehicle, since the operator style is a good predictor of the demands likely to be placed on the vehicle. Thus, the adaptation moves from being purely reactive to being anticipatory.

In a variant, the operator profile(s) is or are derived at least partly on the basis of data based on signals from at least one vehicle sensor. An effect is to provide a more objective characterisation of an operator, e.g., a driver of a car or rider of a motorbike.

In a further variant, determining an appropriate set of program data based on the analysis includes obtaining information for identifying an operator of the vehicle and selecting an operator profile of the operator from one of a plurality of operator profiles associated with the vehicle. This variant takes into account that a vehicle may have several regular operators. It allows for a separation of operator profiles, and contributes to improving the adaptation of the electronic control system.

In an embodiment, the set of program data includes at least one control map, including data representative of an operating envelope and/or adaptation parameters, for an electronic control system including a map-based controller. An effect is to bring about an adaptation of control strategy that is relatively easy to implement. Moreover, it is amenable to automation.

In an embodiment, the electronic control system includes at least one electronic control unit for controlling at least a component of an engine. An effect is to adapt the vehicle's performance most effectively to the conditions under which it is operated, since the engine performance has the greatest effect on the overall vehicle performance. Moreover, in particular in the case of internal combustion engines, the engine performance requires most adaptation to changing conditions, being relatively sensitive to changing conditions and determinative of many key performance indicators, such as fuel efficiency, speed, etc.

In a variant, determining an appropriate set of program data includes establishing a set of program data having an effect of improving the efficiency of the engine under conditions to be expected and determined in accordance with the analysis. An effect is to improve the fuel efficiency of the vehicle. Conventionally, engine performance is determined by factory-installed maps, which are designed on a “one-size-fits-all” basis, and are thus not optimised for any particular pattern of vehicle usage, or operating style. They tend to be biased towards reducing component wear (and hence warranty repair costs), rather than anything else. When a manufacturer releases a vehicle onto the market, it has to be able to cope with many different demands in many different environments. For example, a car has to be able to cope with poor fuel quality, poor servicing, etc., and at the same time provide reliability and economy. This means that manufacturers have to make a compromise, viz. “de-tune” the car. Therefore, there is scope for optimising fuel economy, which is of concern due to environmental regulations.

An embodiment of the method includes causing a programming unit on board the vehicle to program a set of data into the programmable non-volatile memory for adjustment of use of components of the engine to modify the maximum output of an internal combustion engine. An effect is to be able to avoid flat spots and increase fuel economy by operating at close to optimum. In effect, it allows for the electronic control system to be adapted such that the accelerator pedal becomes a means of indicating required power, as opposed to a throttle control. This embodiment is based on the recognition of the fact that internal combustion engines achieve optimum specific fuel consumption at a certain percentage of their maximum output, not just at particular ranges of Revolutions Per Minute. An implementation would, for instance, include modifying a control strategy for selectively switching cylinders on and off, based on expected engine loads.

In an embodiment, the programming unit is included in a unit connected to a port of an on-board diagnostic system of the vehicle. An effect is to obviate the need for physically modifying electronic control units, and to make the method potentially suitable for after-market implementation. On-board diagnostic systems are generally standardised in terms of communication protocols and also external ports.

In an embodiment, the data based on sensor signals is obtained via a diagnostic unit plugged into a port for interrogating an on-board diagnostic system, wherein the diagnostic unit communicates with the electronic control system using at least partly a proprietary protocol of the electronic control system. An effect is to help eliminate the dependency on the often limited maximum data rate of conventional on-board diagnostic systems. The standards for such systems are generally laid out to accommodate devices according to the lowest common denominator.

According to another aspect, the system for configuring an electronic control system for controlling the operation of at least one component of a vehicle according to the invention is characterised in that the programming unit is provided on board the vehicle and in that the system is configured to cause the programming unit to program the appropriate set into the programmable non-volatile memory of the electronic control system. In an embodiment, the system is configured to execute a method according to the invention.

According to another aspect of the invention, there is provided a computer program including a set of instructions capable, when incorporated in a machine-readable medium, of causing a system having information processing capabilities to perform a method according to the invention. The computer program can be used locally within the vehicle or used to implement a distributed system including a server in a network with which the vehicle is arranged to interface.

According to a further aspect of the invention, there is provided a system for configuring a vehicle including a server connected to one or more client computers over a publicly available network, such as the Internet, the server arranged to provide a user interface to the one or more client computers through which a user can make a selection and to generate instructions for configuring a vehicle to alter a driving performance of the vehicle based on the selection.

According to a yet another aspect of the invention, there is provided a method for configuring a vehicle including receiving a selection from a user over a publicly available network, such as the Internet, and generating instructions for configuring a vehicle to alter a driving performance of the vehicle based on the selection. The instructions may include program data for programming into a programmable non-volatile memory of an electronic control system of the vehicle.

These and other objects, along with the advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In addition, the drawings are not necessarily to scale, emphasis instead generally being placed upon illustrating the principles of the invention. In the following description, various embodiments of the present invention are described with reference to the following drawings, in which:

FIG. 1 is a schematic diagram of a vehicle and a telematics interface for providing mapping updates to the vehicle;

FIG. 2 is a flow chart showing a process of providing mapping updates in outline;

FIG. 3 is a flow chart showing a first embodiment of a step in the method of FIG. 2;

FIG. 4 is a flow chart showing a second embodiment of a step in the method of FIG. 2;

FIG. 5 is a flow chart showing a method of providing insurance in accordance with the invention;

FIG. 6 is a schematic diagram of a system for providing insurance in accordance with the invention; and

FIG. 7 shows a display of an interface provided by the system shown in FIG. 6.

### DETAILED DESCRIPTION

Methods and systems for reconfiguring a vehicle, and in particular an electronic control system of a vehicle, are discussed herein using the example of a motor car 1. They are equally applicable to other types of vehicles, particularly motor vehicles, such as motor bikes, lorries, ships, aircraft, agricultural machinery, etc.

The car 1 includes an Engine Control Unit (ECU) 2 for controlling an internal combustion engine 3 and an electronic control unit 4 for an Electronic Stability Control (ESC) system (not shown in detail). Engine Control Units are also referred to as Power-Train Control Modules (PCM). The ECU 2 is essential to controlling electronic fuel injection. This description will focus on the ECU 2, but is equally applicable to the electronic control unit 4 of the ESC system. The ECU 2 includes a microcontroller 5 and programmable non-volatile memory, here in the shape of an EEPROM 6 (Electronically Erasable Programmable Read-Only Memory). In another embodiment, the EEPROM 6 is integrated in the microcontroller 5. In another embodiment, SRAM (Static Random Access Memory) or DRAM (Dynamic Random Access Memory) memory units backed up by a battery of the car 1 are used instead of the EEPROM 6. In yet another embodiment, flash RAM is used. The ECU 2 further includes an output stage 7 for providing output signals to engine components such as:
fuel injectors (length of time each valve remains open);
a fuel pump relay;
an evaporative emissions system;
an exhaust gas recirculation system;
ignition timing and knock sensing components;
an apparatus for adjusting an intake manifold length; and
output devices for self-diagnosis of faults, indicated by a visual indicator on the ECU 2 or a malfunction indicator lamp or check engine warning light on an instrument panel of the car 1.

The output stage 7 can include a circuit known as a quad driver to produce voltage levels—these range between five and twelve Volts—necessary to operate automotive actuators

The ECU 2 also includes an interface 8 to a serial vehicle bus, e.g. a CAN (Controller Area Network) bus (not shown). The ECU 2 receives input signals from at least one vehicle sensor through the interface 8 and/or through an input stage (not shown), to which sensor leads are directly connected. Examples of sensors providing input signals include:
an Engine Coolant Temperature (ECT) sensor;
an Intake Air Temperature (IAT) sensor;
a Throttle Position (TP) sensor;
a Load sensor volume/mass air flow (VAF/MAF) sensor manifold or absolute pressure (MAP) sensor;
a Vehicle Speed Sensor (VSS);
a Crank Shaft Position (CSP) sensor;
a Cam Shaft Position (CMP) sensor;
an Engine speed (RPM) sensor;
an Oxygen sensor (O2S);
a Knock sensor (KS); and
a Barometric pressure (BARO) sensor.

The MAP sensor is preferred over the VAF/MAF sensor, because it is better at responding to the addition of a forced induction system or severe changes in atmospheric pressure. In the case of a MAF sensor, the ECU 2 uses feedback from a speed sensor and a look-up table based on the assumption that there is a certain amount of airflow at a certain speed. The look-up table can be stored in the EEPROM 6, for instance.

The vehicle may also include a sensor (not shown), such as a sensor for receiving a unique code associated with the driver communicated by an ignition key or a switch operated by the driver, in order that the ECU can indentify the driver operating the vehicle. An environmental sensor 34, such as a temperature sensor or humidity sensor, may be provided for detecting an attribute of the environment external to the vehicle.

The ECU 2 controls at least part of the functionality of the engine 3 by processing the input signals in accordance with program data read at least partly from the EEPROM 6. The actual instructions are read from (non-reprogrammable) Read-Only Memory (ROM) (not shown), in some embodiments. Depending on the features of the car 1, the ECU 2 will have a varying list of functions to perform. In a typical car 1 with a limited set of features, the ECU 2 controls fuel delivery, timing advance and anti-smog equipment. With an increase in engine speed (RPMs), it will increase the timing setting. When the accelerator pedal is pressed down significantly, it increases fuel and air delivery in order to provide more speed, and sometimes advances the timing still further to add power. If a knock sensor detects detonation, the ECU 2 will retard the timing to preserve the engine 3. The simplest versions of the ECU 2 (e.g. those used with engines without fuel injection) do nothing more than control timing advance and smog equipment for best possible emissions, and perhaps also fuel delivery.

The use of electronic fuel injection is of benefit to the environment. The ECU 2 monitors the output from an oxygen sensor (not shown), and adjusts air flow and fuel delivery accordingly. It also controls a smog system, and will add fresh air to the exhaust, which helps to burn unburnt fuel there. Where the car 1 is fitted with a smog pump, which forcibly blows air into the exhaust system, this pump is also controlled by the ECU 2.

In a particular embodiment, the ECU 2 implements a speed limiter to keep the vehicle speed below a certain maximum. In a further embodiment, the ECU 2 implements a rev limiter, to avoid over-revving the engine 3, revving of the engine above a predetermined level or reduces the engine speed when the timing advance cannot eliminate detonation. In a variant, the car 1 is provided with a combination of these latter functions, with different limits on the engine speed for different gear combinations.

Where the car 1 is fitted with variable valve timing, the ECU 2 controls intake and exhaust timing, sometimes also during valve lift and duration.

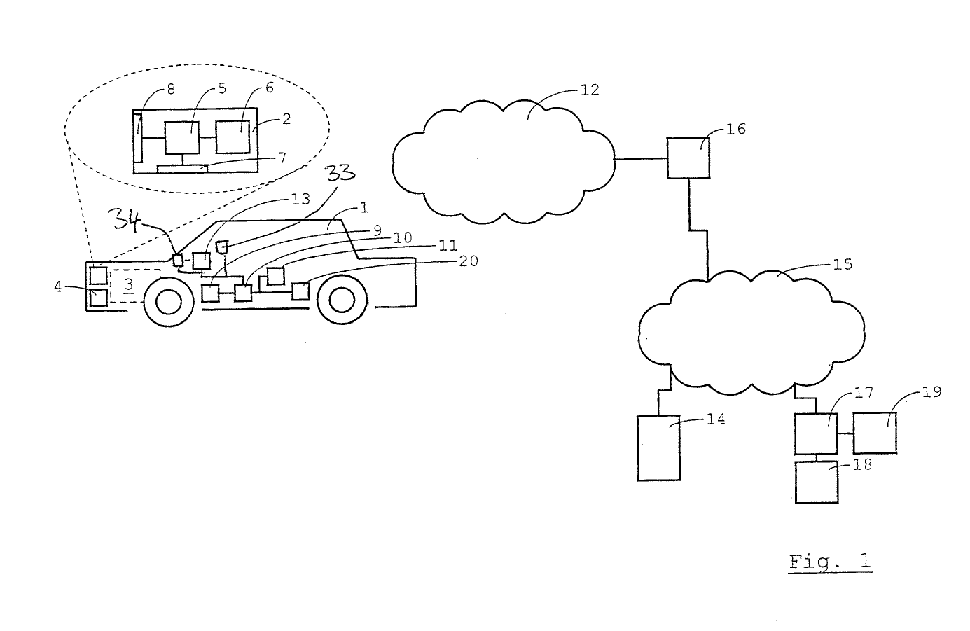

The ECU 2 implements a mapping controller, adapting its control of the engine 3 within an operating envelope using adaptation parameters. The data representative of the operating envelope and adaptation parameters are stored in the EEPROM 6, in addition to data representative of executable program code. This data may be encrypted. The controller map data include an ignition timing map, for instance. As will be explained in detail below, the system of FIG. 1 allows for dynamic re-mapping of the ECU 2 to provide an operating envelope and adaptation parameters that are customised exactly to suit the actual use and operation of the car 1.

An external interface to the vehicle bus is provided by a port 9, into which a Remote Telematics Unit (RTU) 10 is plugged, or to which it is otherwise connected. The port 9 preferably conforms to one or more standards for on-board diagnostic systems, e.g. OBD-II or EOBD. The port 9 is a component fitted as standard to most modern cars, usually within the passenger compartment, e.g., under the dashboard. It is conventionally used for connecting diagnostic tools when the car 1 is being serviced. In the illustrated embodiment, communication is in accordance with international standard ISO 15765. In other embodiments, a different type of vehicle bus is used, and the communications between the RTU 10 and the bus are in accordance with another standard, e.g., SAE J1850, ISO 9141-2 or ISO 14230.

ODB-II has been the industry standard format for on-board diagnostics across most vehicle marquees since 1996. In 1998, the Society of Automotive Engineers set a standard connector plug and a set of diagnostic protocols. However, OBD-II being a worldwide standard has its limitations in terms of speed and functionality. For performance tuning purposes, it is very limited, since the rate of information retrieval is too low. Since all new cars must support OBD-II or the European variant EOBD, the standard is the lowest common denominator. It is a standard that must be achievable by any vehicle, including middle-class cars, vans and top-of-the range cars. The standard requires that an OBD-II reader must not request data from the ECU 2 at more than a couple of single data values per second, even if the ECU 2 is capable of a much higher speed. For this reason, the RTU 10, in one embodiment, uses a custom protocol over the standard protocol for its programming and diagnostic functionality (the functionality described below in detail). This protocol is generally a protocol used by garage tools designed for identifying faults and performing key tasks such as re-tuning, electronic maintenance and re-mapping of the ECU 2. It is characterised by higher data rates than those provided by the standard protocol of the vehicle bus. In another embodiment, the RTU 10 is capable of using any one of a number of protocols.

The RTU 10 includes a functional unit for (re-) programming the ECU 2 via the port 9 and vehicle bus. Thus, the standard mapping data stored in the EEPROM 6 can be replaced by a mapping as required.

In the illustrated embodiment, re-mapping can be carried out remotely through a network connection to the car 1. The RTU 10 has an interface to a cellular transceiver 11 providing a connection to a mobile phone network 12. In other embodiments, other types of interfaces to wireless networks are provided, e.g. WiMax or Bluetooth. In yet other embodiments, such a transceiver is integrated into the RTU 10.

As an alternative to re-mapping over the air, the RTU 10 can be implemented as a stand-alone device, but provided with a memory device for storing a set of data for providing any of a plurality of control maps for re-programming the ECU 2. For more versatility, the RTU 10 optionally includes a read unit (not shown) for reading a portable data carrier storing such data, e.g. an optical disk or solid-state memory device such as an SD-card, Memory Stick, USB memory key, etc.

In the illustrated embodiment, a multi-functional in-vehicle unit 13 is provided, which includes a user interface, e.g. a graphical user interface implemented by means of a touch screen. In an embodiment, the RTU 10 directs reports to the in-vehicle unit 13 via a wired or wireless connection. In another embodiment, the RTU 10 and in-vehicle unit 13 are integrated into one device. The multi-functional in-vehicle unit 13 provides a user interface that allows the user to initiate a method of re-mapping the ECU 2 in one embodiment and/or to confirm that a suggested re-mapping should take place.

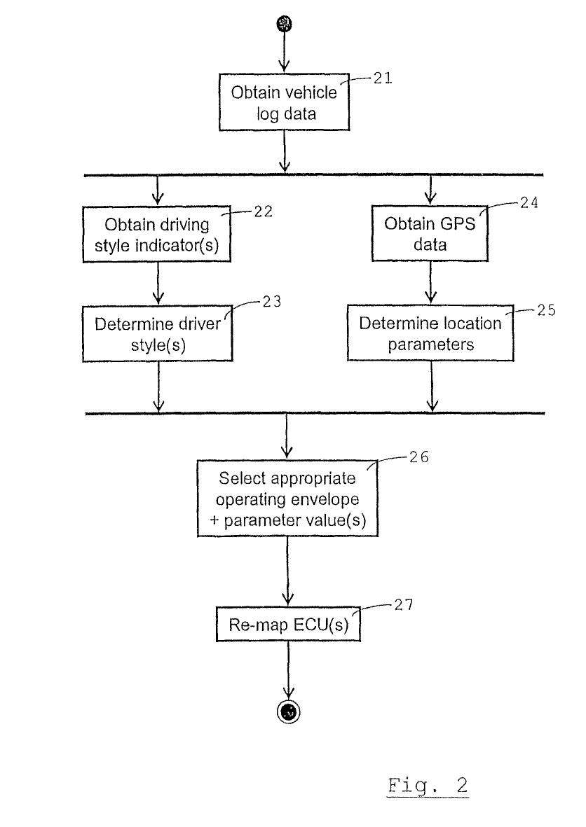

In the embodiment illustrated in FIG. 1, a remote computer 14 is configured to communicate with at least the RTU 10 via a wide-area computer network 15, e.g. the Internet, and a gateway 16 to the mobile telephone network 12. A user, e.g. a fleet manager can log in to an account on the remote computer 14 using a personal computer 17, provided with an input device 18 (mouse and/or keyboard, etc.) and an output device 19 (screen and/or printer, etc.). Thus, the user can obtain an overview of data pertaining to the car 1 and/or its driver. For example, a web interface can be provided by the remote computer 14 that allows a user of the PC 17 to view fuel economy data pertaining to the car 1. Using such data, the user may determine that it is time to re-program the ECU 2 in order to improve the fuel economy. Optionally, the web interface may allow the user of the PC 17 to initiate a method as illustrated in FIG. 2, and to interact with the remote computer 14 as the latter carries out this method.

Referring to FIG. 1, in one embodiment, the RTU 10 is arranged to monitor physical parameters associated with the car 1. It retrieves data based on signals from at least one vehicle sensor by querying vehicle devices or monitoring data on the vehicle bus by means of its connection to the port 9. The RTU 10 records these parameters for real-time or deferred transmission to the remote computer 14 in the shape of a log. Parameters that are monitored include at least one of:
Engine Revolutions Per Minute;
Speed;
Distance;
Acceleration;
Deceleration;
Fuel consumption;
Throttle position; and
Gear ratio.

In addition, the RTU 10 interfaces with a GPS receiver 20 in order to obtain data indicative of the location of the car 1. Where a log is maintained, the location data is time-stamped. Where it is transmitted to the remote computer 14 continually, the timing information is implicit, in that the position is always a generally current one.

Steps in a method of the invention the ECU 2 are shown in FIG. 2. This method may be initiated automatically at regular intervals, when at least one performance indicator of the car 1 meets a certain criterion or upon receipt of a message from a user. Examples of messages include an SMS sent by a mobile phone (not shown), a command from the PC 17 or a message initiated using the in-vehicle unit 13.

In the illustrated method, the remote computer 14 receives the log data 21 assembled by the RTU 10. Next (step 22), it obtains those data that allow it subsequently (step 23) to determine at least one driver profile that indicates the driving style of the driver, based on the location of the car 1 and the parameters associated with the car whilst it is being driven. A suitable method for obtaining a driver profile is set out in EP-A1-1 811 481. The driving style indicators are based on the parameters monitored by the RTU 10 and mentioned above. For example, the engine RPM can be monitored to determine how aggressively the vehicle is being driven. The vehicle speed can be compared to the local speed limit using the location data. It can also be used to determine the type of road travelled on most often (city traffic, long-distance motorway driving, etc.). It may be desirable to re-map the ECU 2 to operate the engine 3 in a regime most appropriate to a particular type of road, particularly in respect of fuel economy.

It is observed that the vehicle log may cover a period of time in which two or more drivers were using the car 1. In an embodiment, the analysis is able to discern between different driver profiles, and/or to obtain an identification of the driver in association with the driving style indicators. For example, different drivers may have different ignition keys and the RTU 10 may record the data in association with an identifier corresponding to one of the keys. Alternatively, the driver may be prompted to enter an identification using the in-vehicle unit 13, or to enter a personalised code to disarm an immobiliser. In an alternative embodiment, the analysis is configured to detect transitions between time intervals corresponding to different styles of usage of the car 1. These different styles are each associated with an anonymous user (e.g. driver #1, driver #2, etc.).

Concurrently, the GPS data is retrieved (step 24) from the data received by the remote computer 14. It is used (step 25) to obtain location-dependent parameters for determining an appropriate set of program data for the ECU 2. In an embodiment, the current location is used to search geographically tagged information in a geographic database for relevant parameters. In particular, these may include the local temperature, humidity, regulations (speed, emissions, etc.), visibility, average gradients, etc.

Next (step 26), the remote computer 14 analyses the data generated in the preceding steps 23,25, and determines an appropriate set of program data for re-programming the ECU 2. In particular, the remote computer 14 selects the appropriate values for the operating envelope and support parameter value(s) that define the control map for the engine 3. Other program data can be determined and include, for example, the number of cylinders to be used. This would be the case where the engine 3 is suitable for selective switching of cylinders, the number being based on expected engine load.

Finally (step 27), the RTU 10 is caused to program the set of program data into the EEPROM 6 of the ECU 2.

Referring to FIG. 3, the step 27 of re-mapping the ECU 2 includes a step 28 of sending the set of program data to the RTU 10 through the network 12 in one embodiment. The RTU 10 then automatically re-maps (step 29) the ECU 2 at an appropriate time. In another embodiment (not shown), the RTU 10 is provided with a number of pre-determined sets of program data, and the remote computer 14 transmits an identifier associated with one of these sets to the RTU 10 wirelessly. In yet another embodiment, the entire method of FIG. 2 is carried out by the RTU 10. In that case, the RTU 10 uses one of a number of sets of program data on a data storage medium, or requests a download from the remote computer 14 to effect the step 27.

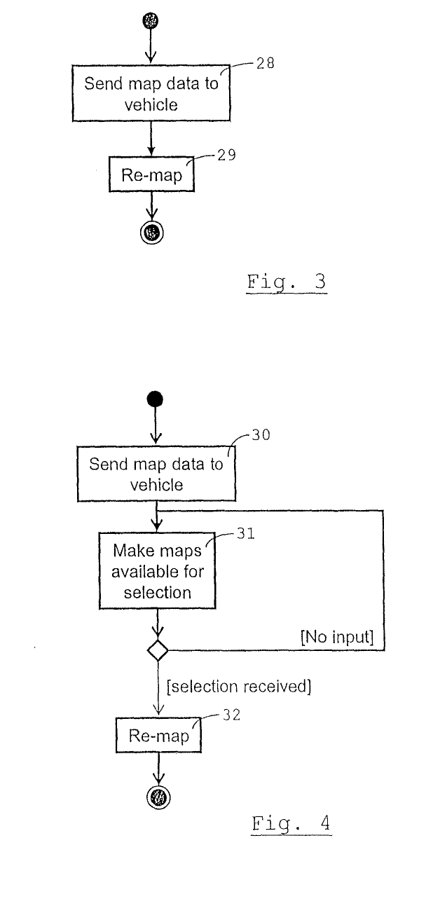

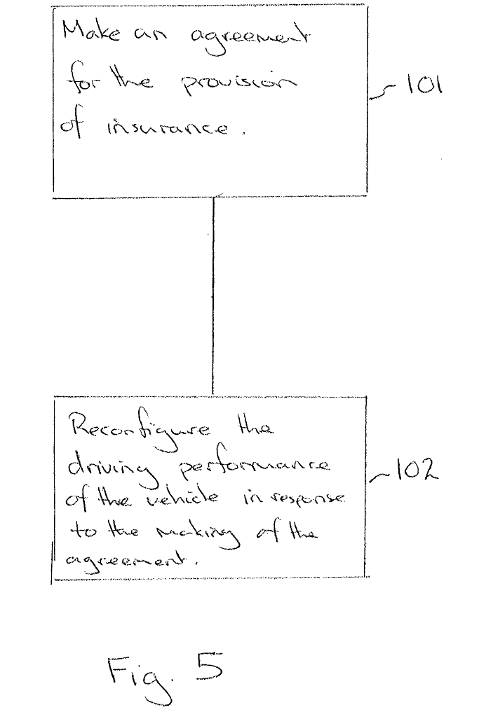

In the embodiment of FIG. 4, the remote computer 14 sends (step 30) the program data to the RTU 10. The RTU 10 prompts (step 31) the driver to re-map the ECU 2. In an embodiment, the remote computer 14 determines an appropriate set of program data for each of a plurality of drivers, and the step 31 of making the program data available includes prompting the driver for information identifying him or her. In another embodiment, the driver is offered a choice of settings, depending on his or her intended use of the car 1, but taking into account the location and/or state of the car as determined by analysing data based on vehicle sensor signals. For example, the user may be offered a choice between two sets of program data based on his driving style and the location, but one being appropriate to the car 1 when otherwise unoccupied and another to the car 1 when towing a caravan (not shown). When the appropriate user input is received, the ECU 2 is re-programmed (step 32).

Effects attainable using the systems and methods described above include one or more of the following: increased fuel economy, increased performance, increased drivability, decreased turbo lag and wear, less un-burnt fuel (soot in Diesel engines), lower emissions, and a lower fuel bill. The results will vary from vehicle to vehicle, the most prominent effects being achieved in vehicles with a forced induction engine 3.

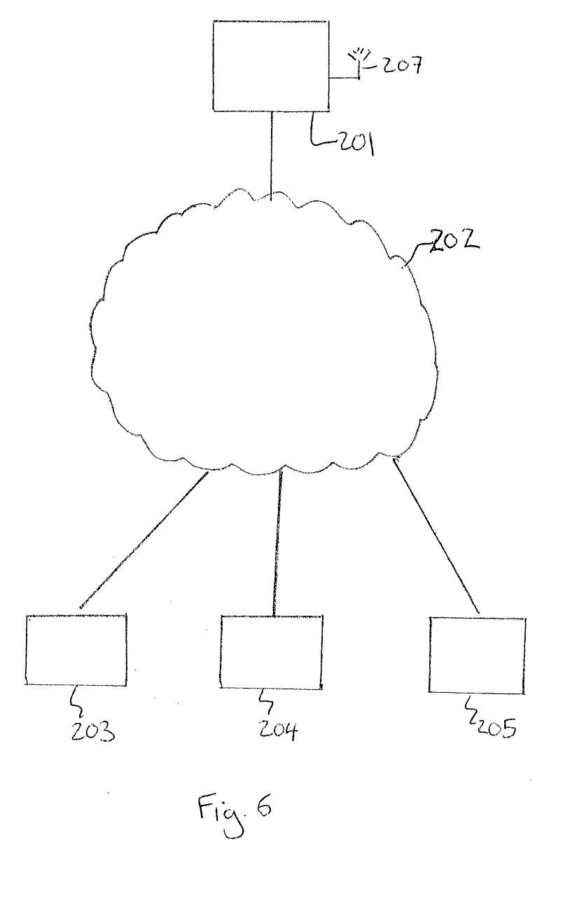

FIG. 5 illustrates a further embodiment of the invention. In this embodiment, in step 101, the owner/driver of a vehicle enters into an agreement with another party, such as an insurance company, for that other party to provide insurance for the vehicle such that the owner/driver is compensated either financially or through repair of the vehicle if the vehicle is damaged, stolen, use of the vehicle results in harm to a third party, etc. As part of this agreement, the driver/owner agrees that his vehicle is reconfigured to alter the driving performance, such as by limiting the maximum engine revolutions per minute, maximum speed, maximum acceleration, maximum deceleration, possible throttle positions. In step 102, the vehicle is reconfigured to alter the driving performance of the vehicle based on the agreement. The vehicle may be reconfigured by and causing the RTU 10 to re-program the ECU 2 with appropriate program data. This program data may be sent to the RTU 10 remotely via transmitter 11, for example, by the insurance provider, or locally, for example by the driver or an employee or contractor of the insurance provider. The performance of the vehicle may be altered in ways that the insurance provider believes will reduce the chance of the vehicle being involved in an incident that would result in the insurance provider having to provide compensation. Alternatively, the performance of the vehicle may be altered in a manner that reduces the emissions of the vehicle in response to making of the insurance agreement.

The vehicle may be reconfigured with program data for a plurality of drivers and the vehicle selects appropriate program data based on the driver detected through sensor 33. For example, the insurance agreement may provide insurance of the vehicle for a plurality of drivers and the driving performance may be set in accordance with which one of the plurality of drivers is currently using the vehicle. The insurance agreement may require that the vehicle has a lesser driving performance depending on the age, gender or physical capabilities of the driver. For example, the driving performance of the vehicle may be reduced for drivers under the age of 25 or above the age of 60, for male drivers or for drivers with poor eyesight. The program data may be reactive to signals from sensors on the vehicle to alter the driving performance based on how the vehicle is driven.

The vehicle may also be reconfigured with program data that changes the driving performance of the vehicle dependent on the external environmental conditions measured by sensor 34. For example, if the external temperature is 0° C. or less then the driving performance of the vehicle may be reduced in order to reduce the chance of an accident occurring as a result of the vehicle coming into contact with snow or ice.

The ECU 2 may provide feedback on how the vehicle is driven and the ECU 2 may be periodically reconfigured as part of the insurance agreement based on the feedback from the ECU 2. Alternatively, the ECU 2 may be reconfigured as part of the insurance agreement based on the event history of the vehicle, for example, dependent on whether an insurance claim has been made on the vehicle.

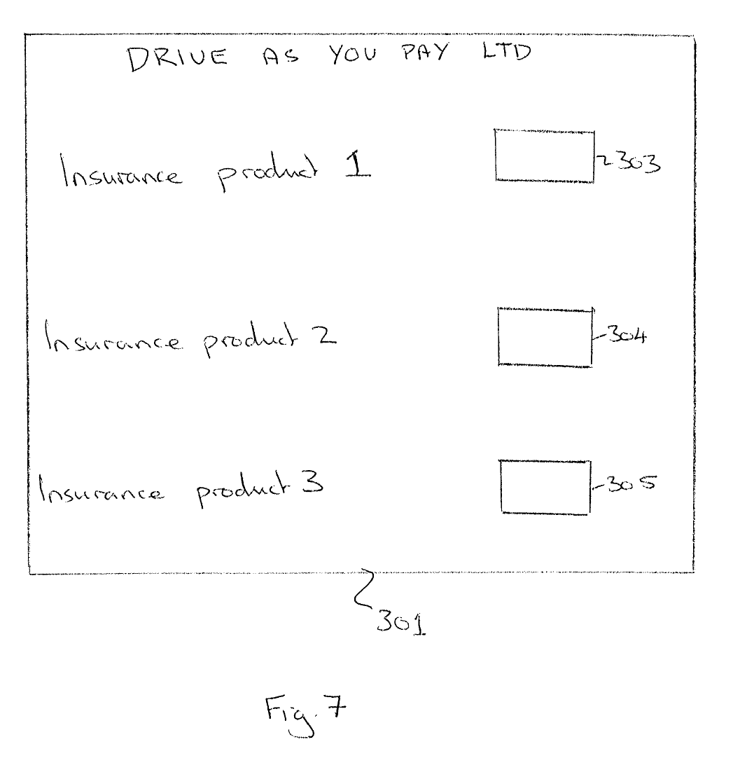

FIG. 6 shows a system for carrying out the method described with reference to FIG. 5. The system includes a server 201 connected via a publicly available network, such as the Internet 202, to one or more client computers 203 to 205 and the server 201 includes a transmitter 207 for transmitting control signals 206 to a receiver 34 in a vehicle. The server 201 is arranged to provide a user interface including a display 301 to client computers 203 to 205, such as that shown in FIG. 7, through which a user can make an agreement for the provision of insurance.

In this embodiment, the display 301 includes a list of insurance products offered by one or more insurance companies and the interface includes a selector 302 corresponding to each of the listed insurance products, in this embodiment a button 303, 304, 305 on the display 301 which a user can select with a mouse pointer, for selecting and, optionally, agreeing to an insurance agreement. In response to the selection of an insurance product by the user, the user may be directed to further displays of the interface (not shown) for the input of further details, such as a vehicle identity, such as the vehicle's number plate, the user's driving history, personal details and bank details for online payment.

On completion of the transaction, the user is deemed to have agreed to an insurance agreement and the server 201 generates instructions for reconfiguring a vehicle to alter the driving performance of the vehicle dependent on the agreement agreed to by the user. The server 201 sends the instructions to the vehicle by transmitting a wireless control signal 206 to the vehicle via transmitter 207. In response to receiving the control signal 206 via transceiver 11, a program unit, RTU 10, programs the non-volatile memory 6 of the ECU 2 with the program data contained in the control signal 206.

In another embodiment, the system is not associated with insurance products, but is arranged to reconfigure the driving performance of a vehicle based on selection of another product or service by the user through an interface. For example, the interface could simply provide a portal for a driver/user/owner to modify the driving performance of his/her vehicle as desired. Alternatively, the system may be associated with the purchase of another service, such a vehicle/road tax, and the system reconfigures the driving performance of the vehicle in response to the purchasing of a particular type of service, such as a particular type of vehicle/road tax, for that vehicle. In yet another embodiment, the system may be associated with a selection of a journey and the system reconfigures the driving characteristics of the vehicle in response to the selected journey, for instance, so as to maximise the vehicles performance in terms of fuel efficiency, emissions or speed during that journey.

The foregoing has been a detailed description of illustrative embodiments of the invention. Various modifications and additions can be made without departing from the spirit and scope of the invention. Each of the various embodiments described above may be combined with other described embodiments in order to provide multiple features. Furthermore, while the foregoing describes a number of separate embodiments of the system and method of the present invention, what has been described herein is merely illustrative of the application of the principles of the present invention. Accordingly, the invention is not limited to the embodiments described above, which may be varied within the scope of the accompanying claims. For example, the re-mapping may take place automatically at pre-set or user-adjustable intervals, or it may take place when particular performance indicators transcend a pre-set threshold. In an alternative embodiment, the location of the car 1 is determined with respect to the mobile telephone network 12 by determining the cell of the network it is in, so that the GPS receiver 20 is not required. In a further embodiment, the methods illustrated herein are used also or alternatively to re-program the Electronic Control Unit 4 for the ESC system fitted to the car 1. For example, the control strategy for a hill descent system can be modified to take account of the fact that the vehicle is being driven off-road or in an area with steep gradients.

What is claimed is:

1. A method of providing insurance comprising making an agreement to provide insurance for a vehicle and reconfiguring the vehicle to alter a driving performance of the vehicle based on the agreement.

2. A method according to claim 1, wherein reconfiguring the driving performance of the vehicle comprises altering one or more of the acceleration characteristics, deceleration characteristics, maximum speed, maximum engine revolutions per minute and characteristics of the vehicle that affect emissions from the vehicle.

3. A method according to claim 1, wherein reconfiguring the driving performance of the vehicle comprises causing the driving performance of the vehicle to change periodically.

4. A method according to claim 1, wherein reconfiguring the driving performance of the vehicle comprises causing the driving performance to change when a specified driver is identified by the vehicle as using the vehicle.

5. A method according to claim 4, wherein the driving performance may be selected from one of a plurality of driver profiles associated with the vehicle.

6. A method according to claim 1, wherein reconfiguring the driving performance of the vehicle comprises causing the driving performance to change in response to the detection of specified ambient conditions by the vehicle.

7. A method according to claim 1, wherein the step of reconfiguring the driving performance of a vehicle comprises reconfiguring an electronic control system for controlling the operation of at least one component of a vehicle, the electronic control system comprising:
a microcontroller;
programmable non-volatile memory, wherein the microcontroller is configured to process input signals from at least one vehicle sensor to provide output signals for controlling the at least one vehicle component in accordance with program data read at least partly from the programmable non-volatile memory; and
an interface enabling a programming unit to program at least part of the program data into the programmable non-volatile memory;
the method further comprising causing a programming unit on board the vehicle to program an appropriate set of program data into the programmable non-volatile memory.

8. A method according to claim 7, wherein the electronic system comprises a receiver for receiving wireless control signals from a remote location and causing the programming unit on board the vehicle to program the appropriate set of program data into the programmable non-volatile memory comprises generating an appropriate control signal at a remote location.

9. A method according to claim 7, comprising:
obtaining data based on sensor signals and pertaining to the vehicle during its operation;
analysing the data based on sensor signals; and
determining an appropriate set of program data based on the analysis.

10. A method according to claim 9, wherein the data based on sensor signals and pertaining to the vehicle during its operation comprises data indicative of a position of the vehicle, at least implicitly associated with timing information.

11. A method according to claim 9, wherein the data based on sensor signals and pertaining to the vehicle during its operation comprises data based on signals from at least one vehicle sensor.

12. A method according to claim 9, further comprising obtaining at least one driver profile that indicates the driving style of at least one driver.

13. A method according to claim 12, wherein the at least one driver profile is derived at least partly on the basis of data based on signals from at least one vehicle sensor.

14. A method according to claim 12, wherein determining an appropriate set of program data based on the analysis comprises obtaining information for identifying the driver of the vehicle and selecting one driver profile from one of a plurality of driver profiles associated with the vehicle.

15. A method according to claim 7, wherein the set of program data comprises at least one control map, including data representative of an operating envelope and/or adaptation parameters, for an electronic control system comprising a map-based controller.

16. A method according to claim 7, wherein the electronic control system comprises at least one Electronic Control Unit for controlling at least a component of an engine.

17. A method according to claim 16, wherein determining an appropriate set of program data comprises establishing a set of program data having an effect of improving the efficiency of the engine under conditions to be expected and determined in accordance with the analysis.

18. A method according to claim 16, further comprising causing a programming unit on board the vehicle to program a set of data into the programmable non-volatile memory for adjustment of use of components of the engine to modify the maximum output of an internal combustion engine.

19. A method according to claim 7, wherein the programming unit is comprised in a unit connected to a port of an on-board diagnostic system of the vehicle.

20. A method according to claim 7, wherein the data based on sensor signals is obtained via a diagnostic unit plugged into a port for interrogating an on-board diagnostic system, wherein the diagnostic unit communicates with the electronic control system using a proprietary protocol of the electronic control system.

21. A system for providing insurance comprising a server arranged to provide a user interface through which a user can make an agreement for the provision of insurance and to generate instructions for reconfiguring a vehicle to alter the driving performance of the vehicle based on the agreement.

22. A system configured to execute a method in accordance with claim 1.

23. A data carrier having stored thereon instructions that, when executed by a processor of a server, cause the server to provide a user interface through which a user can make an agreement for the provision of insurance and to generate instructions for reconfiguring a vehicle to alter the driving performance of the vehicle based on the agreement.

24. A system for configuring a vehicle comprising a server connected to one or more client computers over a publicly available network, the server arranged to provide a user interface to the one or more client computers through which a user can make a selection and to generate instructions for configuring a vehicle to alter a driving performance of the vehicle based on the selection.

25. A system according to claim 24, wherein the selection is a selection of one or more of a desired emission characteristic of the vehicle, road/vehicle tax, a journey and a set of performance characteristics of the vehicle.

26. A method for configuring a vehicle comprising receiving a selection from a user over a publicly available network, and generating instructions for configuring a vehicle to alter a driving performance of the vehicle based on the selection.

27. A method according to claim 26, wherein the selection is a selection of one or more of a desired emission characteristic of the vehicle, road/vehicle tax, a journey and a set of performance characteristics of the vehicle.
